(19) United States
(12) Patent Application Publication
(10) Pub. No.: US 2026/0264843 A1
(43) Pub. Date: Sep. 10, 2026

(54) OIL TANK FOR TURBINE ENGINE WITH CENTRIFUGAL IMPELLER COMPATIBLE WITH NEGATIVE G

(71) Applicants: SAFRAN AERO BOOSTERS, Herstal (BE); SAFRAN AIRCRAFT ENGINES, Paris (FR)

(72) Inventors: Stéphane Alain Luc Ghislain BOUGELET, Herstal (BE); Sébastien ORIOL, Paris (FR)

(21) Appl. No.: 18/876,931

(22) PCT Filed: Jun. 21, 2023
(86) PCT No.: PCT/FR2023/000120

§ 371 Date: Dec. 19, 2024

(30) Foreign Application Priority Data
Jun. 24, 2022 (EP) 22315126.7

(51) Int. Cl. B64C 11/38; B64D 27/10; B64D 33/00; F01D 7/00; F01D 25/18; F15B 1/26

(52) U.S. Cl. CPC B64C 11/38; B64D 27/10; B64D 33/00; F01D 7/00; F01D 25/18; F15B 1/26; F05D 2220/323; F05D 2260/70; F05D 2260/98

(57) ABSTRACT

An oil tank for an aircraft turbomachine, including: an enclosure capable of containing the oil and having a main axis intended to be oriented vertically in the mounting position; an oil inlet at an upper part of the enclosure; an oil outlet at a lower part of the enclosure. The oil tank further includes: a wheel arranged in the lower part of the enclosure and capable of being driven in rotation by drive means so as to centrifuge the oil against a retaining wall of the enclosure and against the oil outlet, and thus maintain an oil supply to said oil outlet during flight phases of the aircraft in zero or negative gravity.

### DOMAIN

The invention relates to the field of turbomachine tanks. More specifically, the invention relates to the field of oil tanks used to lubricate turbomachine components, in particular comprising an unducted variable-pitch propeller. and/or a variable pitch rectifier.

### PRIOR ART

Aircraft turbomachines comprising at least one unducted propeller are known by the English term “open rotor” or “unducted fan”. In this category of turbomachine, there are those which have two unducted and counter-rotating propellers (known by the English acronym UDF for “Unducted Dual Fan”) or those having a single unducted propeller and a rectifier comprising several stator blades (known by the English acronym USF for Unducted Single Fan).

These turbomachines are turboprops which are distinguished from turbojets by the use of a propeller outside the nacelle (unducted) instead of an internal fan.

The propeller or propellers forming the propulsion part generally comprise a system for actuating the pitch of the blades of the propeller(s), also referred to as a variable pitch system. Such a system allows the blades of the propeller to be oriented according to the needs of the flight phases of the aircraft (takeoff, cruise, landing, etc.) in order to ensure thrust management in all flight cases of the turbomachine.

In the case of turbomachines with a single unducted propeller and a rectifier, the latter may also comprise a variable-pitch system so as to improve the performance of the turbomachine. An example of such a turbomachine is disclosed by published patent document FR 3 107 319 A1.

Variable pitch systems may require a permanent oil supply to enable the blade pitch to be actuated and the engine thrust to be managed in all flight conditions of the turbomachine (nominal and extreme). In the state of the art, these systems are supplied by a main lubrication circuit to ensure an oil supply to the various components of the engine (bearings, reducer, etc.) to provide lubrication and/or cooling functions. This circuit is supplied with oil by a main tank of the turbomachine comprising, among other things, an oil inlet in the upper part and an outlet in the lower part, which allows an oil supply during flight attitudes under gravity or positive load factor (positive G).

While such tanks are entirely satisfactory when the aircraft is flying in positive G flight situations, on the other hand, when it comes to flight phases under zero or negative load factor (zero G or negative G), i.e., when the aircraft is manoeuvring or in the event of an upward gust of wind, these tanks no longer completely ensure the oil supply to the pitch actuation system.

Indeed, zero-G or negative-G flight phases are temporary flight phases (generally lasting less than 30 seconds for civil aircraft) for which the aircraft is subjected to negative accelerations, for example, when it experiences sudden decreases in altitude.

To this end, the oil contained in the main tank is then spilled, the oil is no longer located near the outlet in the lower part, which generates a cut in the oil supply, causing air to pass towards the variable pitch circuit(s), thus causing harmful consequences on the operation of the turbomachine which may lead to a loss of control of the aircraft.

It is possible to use tanks such as those used in fighter aircraft, where negative G flight phases are frequent and essential. However, these tanks are pressurized, which implies a significant excess weight, as well as a high additional cost, incompatible with turbomachines comprising at least one unducted propeller.

Furthermore, a known solution to avoid harming the propeller pitch actuation circuit is, in the case of negative G, to ensure the oil supply by means of a system other than the main oil tank of the turbomachine. However, such a solution involves significant bulk and mass within the turbomachine and complex management of the oil routing to the variable pitch system.

The published patent document FR 3 010 133 A1 discloses a tank comprising an inclined partition provided at its ends with through holes for continuous supply of the turbomachine. However, the solution proposed by the document has room for improvement in order to allow, for example, a greater volume of oil available to supply the components of the turbomachine in the event of negative G flight, and without hindering said volume when returning to positive G.

### SUMMARY OF THE INVENTION

### Technical Problem

The present invention aims to overcome at least one of the drawbacks of the aforementioned state of the art. More particularly, the invention aims to propose an oil tank whose design is such that it allows the aircraft to carry out, in complete safety, temporary phases of flight in negative gravity, without increasing the weight and cost of the tank.

### Technical Solution

The invention relates to an oil tank for an aircraft turbomachine, comprising:
an enclosure capable of containing the oil and having a main axis;
an oil inlet at an upper part of the enclosure;-an oil outlet at a lower part of the enclosure; wherein the oil tank further comprises:-a wheel arranged in the lower part of the enclosure and capable of being driven in rotation by drive means so as to centrifuge the oil against a retaining wall of the enclosure, and against the oil outlet, hereby maintaining an oil supply to said oil outlet during flight phases of the aircraft in zero or negative gravity.

Advantageously, the oil inlet is an inlet of oil mixed with air.

According to an advantageous embodiment of the invention, the wheel has an axis of rotation parallel to the main axis or inclined at an angle of minus 20° relative to said main axis.

Advantageously, the axis of rotation of the wheel passes through the enclosure, said axis of rotation being capable of being driven by the drive means.

Advantageously, the drive means comprise an electric motor.

Advantageously, the training facilities are located within the enclosure.

According to an advantageous embodiment of the invention, the wheel is adjacent to a bottom wall of the enclosure.

According to an advantageous embodiment of the invention, the retaining wall is conical in shape with a section of smaller diameter and a section of larger diameter.

Preferably, the wheel adjacent to the bottom wall of the enclosure means that the section of smaller diameter is opposite and distant from the bottom wall by a distance corresponding to at most 20% of a total height of the lower part of the enclosure.

According to an advantageous embodiment of the invention, the oil outlet passes through the retaining wall on the section of larger diameter.

According to an advantageous embodiment of the invention, the conical shape of the retaining wall has an angle of between 10° and 50°.

According to an advantageous embodiment of the invention, the retaining wall is a side wall of the enclosure, the section of smaller diameter being adjacent to the bottom wall of said enclosure.

According to an advantageous embodiment of the invention, the wheel has an outer envelope of conical shape parallel to the conical shape of the retaining wall or inclined by less than 20° relative to said conical shape of the retaining wall.

According to an advantageous embodiment of the invention, the enclosure further comprises a transverse wall delimiting in said enclosure an upper compartment comprising the oil inlet and a lower compartment comprising the wheel, the retaining wall and the oil outlet, said transverse wall comprises at least one passage fluidically connecting the lower compartment with the upper compartment.

According to an advantageous embodiment of the invention, the at least one passage comprises a conduit extending from the transverse wall into the wheel.

According to an advantageous embodiment of the invention, the conduit extends over at least 80% of a height of the wheel along a main direction of said conduit.

According to an advantageous embodiment of the invention, the at least one passage comprises a valve capable of allowing a flow of oil from the upper compartment to the lower compartment and of blocking a flow of oil from the lower compartment to the upper compartment.

Advantageously, the oil tank comprises an oil outlet on the upper compartment and adjacent to the transverse wall.

According to an advantageous embodiment of the invention, the oil outlet on the lower compartment is an auxiliary oil outlet, said oil tank comprising an auxiliary oil inlet on said lower compartment.

The invention also relates to a hydraulic system for an aircraft turbomachine comprising:
an oil tank;
a lubrication circuit for the turbomachine, hydraulically connected to the oil tank;
a hydraulic control circuit for at least one hydraulic actuator, hydraulically connected to the oil tank; wherein the oil tank is according to the invention, the lubrication circuit being hydraulically connected to the oil inlet and to an oil outlet, arranged on the enclosure, the hydraulic control circuit being hydraulically connected to the auxiliary inlet and to the auxiliary outlet.

Advantageously, the oil inlet is an inlet of oil mixed with air.

The invention also relates to an aircraft turbomachine, comprising:
an unducted propeller propelling an incoming air flow, said propeller comprising variable-pitch blades actuated by at least one hydraulic actuator;
a hydraulic system capable of providing lubrication of the turbomachine and of controlling the at least one hydraulic actuator;
   wherein the hydraulic system is according to the invention.

The invention also relates to a turbomachine comprising:
an unducted propeller propelling an incoming air flow, said propeller comprising a variable pitch system for actuating the pitch of the propeller blades;
an oil tank for lubricating components of the turbomachine, wherein said tank comprises:
an enclosure capable of containing the oil and having a main axis;
an oil inlet at an upper part of the enclosure;
an oil outlet at a lower part of the enclosure;
a wheel arranged in the lower part of the enclosure and capable of being driven in rotation by drive means so as to centrifuge the oil against a retaining wall of the enclosure and against the oil outlet, and thus maintain an oil supply to said oil outlet during flight phases of the aircraft in zero or negative gravity.

According to an advantageous embodiment of the invention, the variable pitch system is a first variable pitch system, and said turbomachine further comprises a rectifier comprising a plurality of stator blades. extending from a fixed casing, said rectifier comprising a second variable pitch system, and in that the auxiliary output is hydraulically connected to a second closed circuit comprising components of the first system and/or the second variable pitch system of the turbomachine.

### Advantages of the Invention

The invention is particularly advantageous in that it makes it possible to guarantee an oil supply to the various components of the turbomachine, including in particular the variable-pitch system(s), while ensuring that the latter is supplied with pure oil without any presence of air and without interruption of supply during the flight phases in zero gravity and in negative gravity.

Advantageously, the centrifugal force generated by the wheel is capable of pressing the oil against the retaining wall so as to overcome gravity during all phases of flight of the aircraft. Thus, the hydraulic control of the propeller pitch actuation system of the turbomachine can remain operational during all phases of flight of the aircraft.

In addition, the tank is compact, which helps reduce the overall size and mass of the turbomachine.

### DESCRIPTION OF THE DRAWINGS

FIG. 1 is a schematic axial sectional view of an aircraft turbomachine according to the invention;

FIG. 2 illustrates a diagram of a hydraulic system of the turbomachine of FIG. 1;

FIG. 3 represents a sectional view of an oil tank according to the invention;

FIG. 4 shows a variation of the oil tank of FIG. 3;

FIG. 5 shows a sectional view of an oil tank of FIG. 3 during a phase of flight of the aircraft in negative gravity.

### DETAILED DESCRIPTION

The figures show the elements schematically and are not drawn to scale. In particular, some dimensions are enlarged to facilitate reading of the figures.

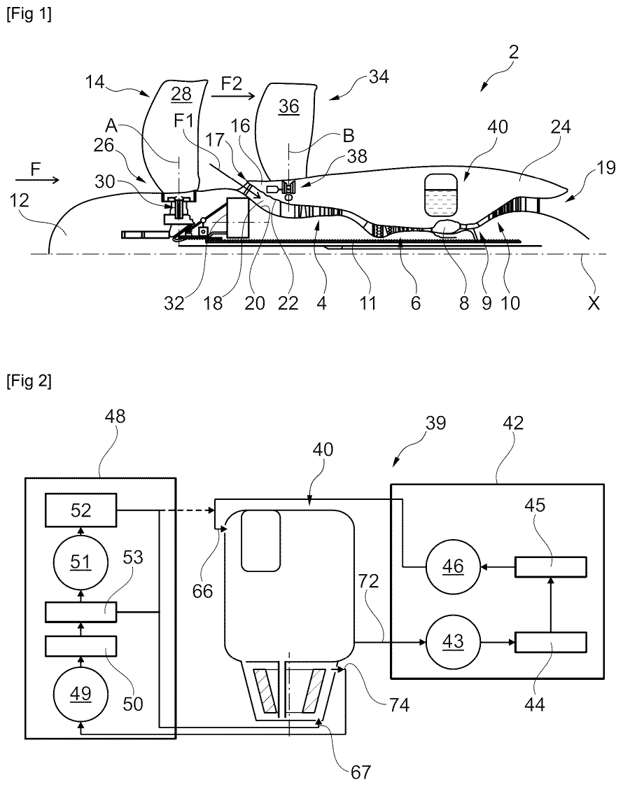

FIG. 1 schematically illustrates an axial sectional view of an aircraft turbomachine according to the invention. This is a turbomachine known by the English expression “open rotor” or “unducted fan”, and particularly a USF “Unducted Single Fan” turbomachine.

In the following description, the terms “internal” and “external” refer to a positioning relative to the axis of rotation of a turbomachine, and here along the longitudinal axis X (and even from left to right in FIG. 1. The terms “radial”, “internal” and “external” are defined relative to a radial direction perpendicular to the longitudinal axis X. Upstream and downstream refer to the direction of flow of a flow in the turbomachine. Furthermore, the elements illustrated in the figures which are identical or substantially identical and/or with the same functions are represented by the same numerical references.

The turbomachine 2 typically comprises, from upstream to downstream, a first compression level, called low pressure compressor 4, as well as a second compression level, called high pressure compressor 6, a combustion chamber 8 followed by a high pressure turbine 9 and a low pressure turbine 10.

The turbomachine 2 comprises a propeller 14 arranged upstream of a separation nozzle 16 carried by an external casing 24 and capable of separating the incoming air flow F into a secondary flow F2 and a primary flow F1 circulating in a primary vein 18 and crossing the various aforementioned levels of the turbomachine 2.

The primary vein 18 is delimited radially by a radially internal wall 20 and a radially external wall 22. The radially internal wall 20 is carried by the internal casing 12. The radially external wall 22 is carried by the external casing 24. The primary air flow F1 enters the primary vein 18 through an annular air inlet 17 and escapes through a primary nozzle 19 which is arranged downstream of said primary vein 18. The primary flow F1 can be accelerated by the primary nozzle 19 so as to generate a thrust reaction necessary for the flight of the aircraft.

The turbomachine comprises a rotating casing 26 centered on the longitudinal axis X and rotating around the latter. The rotating casing 26 carries a crown of movable blades 28 forming the propeller 14. The rotating casing 26 is mounted movable relative to the internal casing 12 which carries it.

The air flow F entering the turbomachine passes through the blades 28 of the propeller 14 to form the secondary air flow F2. The latter circulates around the external casing 24. Each blade 28 of the propeller 14 comprises a root 30 and an aerodynamic part extending radially outwards from the root 30, the latter comprising a pivot. Indeed, the root 30 is mounted pivoting about an axis A (perpendicular to X) thus allowing the blades 28 of the propeller 14 to pivot. This pivoting is managed by a first variable-pitch system of the turbomachine 2.

The low pressure compressor 4 and the low pressure turbine 10 are mechanically connected by a low pressure shaft 11, the latter drives the propeller 14 via a reducer 32, the propeller 14 compresses the air outside the external casing 24 and provides most of the thrust of the turbomachine 2. The reducer 32 may be of the planetary gear type.

The turbomachine 2 comprises a rectifier 34 crossed by the secondary flow F2, the latter being a part of the air flow F propelled radially outwardly to the longitudinal axis X. The rectifier 34 comprises a plurality of stator blades 36 (or stator vanes or fixed vanes) known by the English acronym “OGV” (Outlet Guide Vane). The stator vanes 36 are distributed regularly around the longitudinal axis X and extend radially in the secondary air flow F2. The stator blades 36 are carried by a fixed structure secured to the external casing 24. In particular, each stator blade 36 extends radially from a foot 38, the latter is pivotally mounted about an axis B (perpendicular to X) allowing the stator blades 36 of the rectifier 34 to pivot. This pivoting is managed by a second variable-pitch system of the turbomachine 2.

The turbomachine 2 further comprises an oil tank 40 for the lubrication and/or cooling of the components of said turbomachine 2. For this purpose, the oil tank 40 is the main oil tank of the turbomachine 2, and also makes it possible to supply oil to the first and second variable pitch systems of the turbomachine 2. Preferably, the tank 40 is arranged in line with the external casing 24. The architecture and operation of the oil tank 40, 400 will be detailed later in this description.

FIG. 2 is a diagram of a hydraulic system 39 of the turbomachine of FIG. 1. The hydraulic system 39 comprises different closed circuits connected to the oil tank of the invention.

With reference to FIG. 2, the oil tank 40 is hydraulically connected to a lubrication and cooling circuit 42 of the turbomachine engine, this circuit comprises a feed pump 43, exchangers 44 and engine enclosures 45, the latter ensuring the lubrication of the bearings, reducers and bearings and ensuring the air/oil seal of the engine.

The lubrication circuit 42 further comprises at least one recovery pump 46 configured to recover the oil from the engine enclosures 45 and direct them to the oil tank 40. The circuit 42 may correspond to a lubrication group of the turbomachine.

The oil tank 40 is also hydraulically connected to a circuit 48 for actuating the pitch of the propeller blades, also designated by a hydraulic control circuit 48 for supplying oil to the first variable-pitch system of the turbomachine of FIG. 1, namely the propeller 14.

The hydraulic control circuit 48 can also supply oil to the second variable pitch system of the turbomachine of FIG. 1, namely the rectifier 34, independently or in combination with the first variable pitch system.

The hydraulic control circuit 48 can provide lubrication and/or cooling functions for the variable pitch system. In this regard, the circuit 48 comprises a booster pump 49 recovering the oil from a lower part of the tank 40 to direct it to an exchanger 50.

Preferably, the hydraulic control circuit 48 is also configured to hydraulically control the variable pitch system in addition to the lubrication and cooling functions. In this regard, the circuit 48 comprises a pitch actuation pump 51 capable of hydraulically controlling a pitch actuation system or hydraulic actuator 52, the latter of which may correspond to the first and/or second variable pitch system of the turbomachine.

In this configuration, the step actuating pump 51 makes it possible to actuate the hydraulic actuator 52 causing the pivoting of the feet 30 and 38 of FIG. 1.

Preferably, the hydraulic control circuit 48 comprises a by-pass valve 53 allowing the choice between a cooling function or actuation of the pitch of the variable pitch system.

Advantageously, the hydraulic system 39 comprises a connection (illustrated in dotted lines) between the hydraulic control circuit 48 and the lubrication circuit 42 to collect any leaks from the propeller pitch actuation cylinders and to reinject this oil into the tank 40 from an inlet 66.

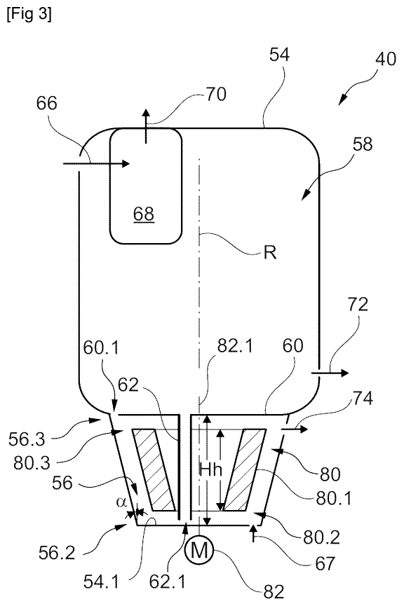

FIG. 3 illustrates a sectional view of the oil tank 40, the latter comprising an oil inlet 66 mixed with air to a main enclosure 54 capable of containing the oil (oil not shown here to better simplify the illustration), and precisely to an oil deaerator device 68, making it possible to evacuate the air 70 mixed with the oil at the oil inlet 66. The oil inlet 66 preferably comes from the at least one recovery pump 46 of FIG. 2.

The main enclosure 54 has a main axis R preferentially corresponding to a main direction R intended to be oriented vertically in the mounting position in the turbomachine 2 of FIG. 1.

Preferably, the main axis R corresponds to the main direction of the extent of the main enclosure 54. For this purpose, the main axis R defines the direction of the largest dimension of said enclosure 54.

Preferably, the main axis R of the enclosure 54 follows the direction of gravity (perpendicular to the horizontal plane). However, the main axis R may be inclined relative to the direction of gravity by an angle of up to 45° or exceed 45° to form an angle of less than 90°.

According to the direction of gravity (force perpendicular to the horizontal and directed downwards), the upper compartment 58 is above the lower compartment 56

Alternatively, the enclosure 54 of the tank 40 may have a substantially oblong and/or curved shape. Preferably, the enclosure 54 comprises a substantially cylindrical shape.

The tank 40 comprises a transverse wall 60 delimiting in said enclosure an upper compartment 58 corresponding to an upper part of the enclosure 54 comprising the oil inlet 66, and a lower compartment 56 corresponding to a lower part of the enclosure 54 and comprising an oil outlet 74.

The tank 40 also comprises an oil outlet 72 preferably arranged in line with a side wall of the upper compartment 58, this oil outlet 72 is preferably adjacent to the transverse wall 60. In this configuration, the oil inlet 66 and the oil outlet 72 form a circuit corresponding to the lubrication circuit 42 of FIG. 2.

The lower compartment 56 is formed by a retaining wall 56.1 corresponding to a side wall of the enclosure 54 and specifically to a side wall of the lower part of the enclosure 54. Preferably, the retaining wall 56.1 comprises a conical circular shape with a smaller diameter section 56.2 and a larger diameter section 56.3. Preferably, the bottom wall 54.1 is formed with the retaining wall 56.1.

Advantageously, the arrangement of the lower compartment 56 inside the main enclosure 54 makes it possible to obtain a rapid exchange of the oil flows between the latter two.

In this configuration, the conical shape of the retaining wall 56.1 has a conicity angle a of between 10° and 50°, and preferably of between 20° and 45°, and more preferably of 30°. The conicity angle a is between the retaining wall 56.1 and the main (vertical) direction, the retaining wall 56.1 may however have an inclination of less than 20° relative to the main direction.

The lower compartment 56 comprises an auxiliary oil inlet 67 preferably arranged in line with the bottom wall 54.1, said auxiliary oil inlet 67 being preferably oriented tangentially to the retaining wall 56.1 in order to give the incoming oil flow an orientation similar to that generated by the wheel 80.

The lower compartment 56 also includes an auxiliary oil outlet 74 passing through the reference retaining wall 56.1 on the larger diameter section 56.3. For this purpose, the auxiliary inlet and outlet 67, 74 make it possible to form a closed circuit in order to supply oil to the hydraulic control circuit 48 of FIG. 2.

Preferably, the inlet 67 is arranged in one end of the bottom wall 54.1 adjacent to the retaining wall 56.1 and close to the auxiliary outlet 74. Advantageously, this makes it possible to minimize the oil path between the inlet 67 and the outlet 74 in the lower compartment 56.

The tank 40 further comprises a wheel 80 arranged in the lower compartment 56 and also having a conical circular shape. Indeed, the wheel 80 comprises an outer casing 80.1 of conical shape parallel to the conical shape of the retaining wall 56.1.

In this regard, the outer casing 80.1 comprises a smaller diameter section 80.2 and a larger diameter section 80.3 each being substantially at the same level as the sections 56.2, 56.3 of the retaining wall 56.1, respectively. Preferably, the smaller diameter section 80.2 of the wheel 80 is adjacent to the lower wall 54.1 of the enclosure 54.

Preferably, the smaller diameter section 80.2 of the wheel 80 is opposite and distant from the bottom wall 54.1 by a distance corresponding to at most 20% of a total height H of the lower compartment 56. The wheel 80 is driven in rotation by drive means 82, the latter being connected to the wheel by means of a shaft (not illustrated) having an axis 82.1 of rotation of the wheel 80 in the lower compartment 56, this axis 82.1 is preferably parallel to the main vertical direction of the tank 40, or inclined by at most 20° from said main direction.

It can be seen in FIG. 3 that the drive means 82 are schematically illustrated externally to the tank and below the bottom wall 54.1. In this configuration, the drive means 82 may correspond to a reducer and/or a right-angle transmission belonging to the turbomachine of FIG. 1. For this purpose, the shaft drives the wheel 80 in rotation following recovery of the rotational movement from the reducer and/or the right-angle transmission. For this purpose, the bottom wall 54.1 may comprise a bearing and at least one seal to ensure the sealing of the lower compartment 56.

However, the drive means 82 may correspond to an electric motor arranged in the lower compartment 56 between the smaller diameter section 80.2 and the bottom 54.1. This motor may also be arranged in the upper compartment 58 and preferably in line with the transverse wall 60. Advantageously, such an arrangement makes it possible to ensure a space saving in the tank 40.

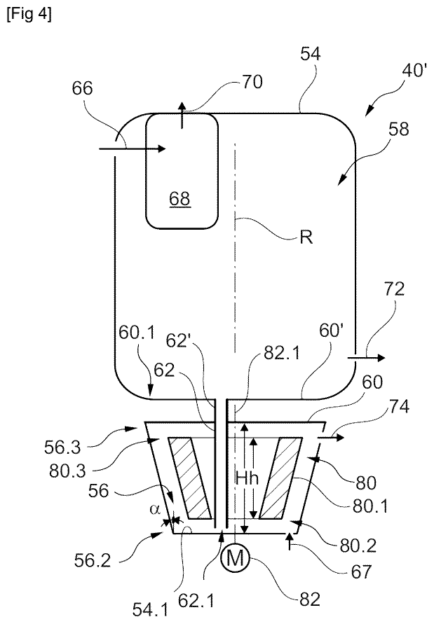

FIG. 4 illustrates an alternative to the tank of FIG. 3, in which the lower compartment 56 of the tank 40′ is arranged externally to the upper compartment 58. Advantageously, this makes it possible to integrate the tank 40′ into a particularly restrictive environment of the turbomachine. In this regard, one or more hydraulic pipes 62′ can connect the two compartments 58 and 54. In this configuration, the hydraulic pipe(s) 62′ can be flexible and/or can be merged with a channel 62 of the lower compartment.

It can be seen in FIG. 4 that the main enclosure 54 of the tank 40′ comprises a transverse wall 60′ corresponding to a bottom wall 60′ of the upper compartment 58. Said wall 60′ can advantageously have a conical shape so as to facilitate the circulation of oil towards the channel 62 during a return to positive gravity after an event in negative gravity.

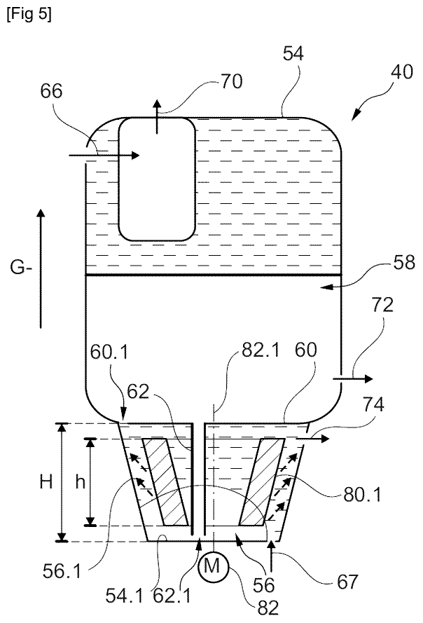

FIG. 5 shows a sectional view of the oil tank 40 during a negative G flight phase of the aircraft. Now, G+ will refer to positive gravity and G− to negative gravity.

It should be noted that the tank 40 is capable of ensuring a constant supply of pure oil during G− flight phases, and each of the G− phases lasts between a fraction of a second and 45 seconds. Advantageously, the tank 40 can be sized so as to ensure a constant supply of oil even beyond 45 seconds.

The transverse wall 60 preferably comprises an oil passage corresponding to a conduit 62 fluidically connecting the upper compartment 58 with the lower compartment 56.

In an alternative not shown, the transverse wall 60 may have a conical shape so as to facilitate the circulation of oil towards the channel 62 during the return to G+.

Preferably, the conduit 62 extends over at least 80% of a height h of the wheel 80, and more preferably, the conduit 62 extends over at least 80% of a total height H of the lower compartment 56 and over the entire height h of the wheel 80. In this configuration, the bottom wall 54.1 of the enclosure 54 is adjacent to a distal end 62.1 of the conduit 62.

Preferably, the conduit 62 extends into the wheel 80 so that the outer casing 80.1 completely envelops the conduit 62. The latter being slightly offset from the axis of rotation 82.1 of the wheel 80 to allow the shaft of the drive means 82 to pass.

Advantageously, the conduit 62 delimits an oil buffer volume at G− between the distal end 62.1 and the transverse wall 60, this oil buffer volume is intended to be sucked towards the auxiliary oil outlet 74 to supply the hydraulic control circuit with oil and without interruption for the entire duration of the event G0 and G− of the aircraft.

Preferably, the height h of the wheel 80 corresponds to approximately 80% (±10%) of the total height H of the lower compartment 56. However, in an alternative not illustrated, the wheel 80 may be entirely located in a lower half of the lower compartment 56. Indeed, the height h of the wheel 80 may be optimized according to the dimensions of the tank 40 and the rotation speeds of the wheel 80. For example, a small wheel 80 close to the bottom 54.1 may be sufficient to generate the quantity of movement necessary to allow the oil to reach the auxiliary oil outlet 74. In this regard, the height h of the wheel 80 may correspond to more than 20% and/or less than 90% of the total height H of the lower compartment 56.

The distal end 62.1 may comprise a non-return valve (not shown), this valve is preferentially sensitive to changes in gravity. For this purpose, the valve is capable of allowing the flow of oil from the upper compartment 58 to the lower compartment 56 in G+ and of blocking the flow of oil from the lower compartment 56 to the upper compartment 58 in G−. This advantageously makes it possible to maximize the retention of oil in the lower compartment 56 in G−.

At the same time, the transverse wall 60 may also comprise a valve (not shown) or a flap sensitive to changes in gravity and making it possible to advantageously keep the oil in the lower compartment 56 in G− and to accelerate the return of oil to said compartment in G+.

In addition, transverse wall 60 may, in addition, comprise a vent 60.1 allowing air to be evacuated quickly from the lower compartment 56 in order to allow a rapid return of the oil to said compartment when the aircraft returns to G+ after G−.

The buffer volume of oil retained during the G− in the lower compartment 56 is centrifuged against the retaining wall 56.1 by means of the wheel 80. In fact, the wheel 80 is driven in rotation for the entire duration of the G0 and the G−. For this purpose, the oil is centrifuged against the retaining wall 56.1 and against the auxiliary oil outlet 74.

Preferably, the drive means 82 drive the wheel 80 in rotation during all the flight phases of the aircraft (G+, G0 and G−). Advantageously, this allows the oil to be constantly pressed against the retaining wall 56.1 in order to reach the outlet 74 (oil movements illustrated in dotted lines) and to further secure the operation and continuous supply of the hydraulic control circuit 48 of FIG. 2.

However, the wheel 80 can be controlled so as to be driven in rotation only during the events G0 and G−, in particular if the drive means 82 correspond to an electric motor.

Preferably, the conical outer casing 80.1 may correspond to a porous surface having several pockets capable of containing the oil in order to maximize the centrifugal force generated on the oil by the rotation of the wheel 80. Similarly, the outer casing 80.1 may comprise hollows or grooves extending over the entire height h of the wheel 80. Preferably, the outer casing 80.1 comprises a scoop conformation and/or several blades (hatched in FIG. 5) extending over the entire height h and advantageously having a spiral trajectory around the axis 82.1. In this configuration, the oil has an annular swirling flow path on the retaining wall 56.1.

Advantageously, the wheel 80 makes it possible to efficiently transmit the centrifugal force to the volume of buffer oil in the lower compartment of the tank 40 so as to induce a flow of oil towards the auxiliary outlet 74.

Advantageously, the turbomachine of the present invention is capable of ensuring continuous and secure operation of its variable pitch systems thanks to the main oil tank making it possible to ensure oil supply in order to supply such systems with pure oil without any presence of air and without interruption of supply during flight phases in zero or negative gravity.

1. An oil tank for an aircraft turbomachine, comprising:
an enclosure configured to contain oil and defining a main axis;
an oil inlet at an upper part of the enclosure;
an oil outlet at a lower part of the enclosure; and
a wheel arranged in the lower part of the enclosure and configured to be driven in rotation by drive means so as to centrifuge the oil against a retaining wall of the enclosure and against the oil outlet, thereby maintaining an oil supply to said oil outlet during flight phases of the aircraft in zero or negative gravity.

2. The oil tank according to claim 1, wherein the wheel has an axis of rotation parallel to the main axis or inclined at an angle of minus 20° relative to said main axis.

3. The oil tank according to claim 1, wherein the wheel is adjacent to a bottom wall of the enclosure.

4. The oil tank according to claim 1, wherein the retaining wall is conical in shape with a smaller diameter section and a larger diameter section.

5. The oil tank according to claim 4, wherein the oil outlet passes through the retaining wall on the larger diameter section.

6. The oil tank according to claim 4, wherein the conical shape of the retaining wall has an angle of between 10° and 50°.

7. The oil tank according to claim 4, wherein the retaining wall is a side wall of the enclosure, the smaller diameter section being adjacent to the bottom wall of said enclosure.

8. The oil tank according to claim 4, wherein the wheel has an outer casing of conical shape parallel to the conical shape of the retaining wall or inclined by less than 20° relative to said conical shape of the retaining wall.

9. The oil tank according to claim 1, wherein the enclosure further comprises a transverse wall delimiting in said enclosure an upper compartment comprising the oil inlet and a lower compartment comprising the wheel, the retaining wall and the oil outlet, said transverse wall comprises at least one passage fluidly connecting the lower compartment with the upper compartment.

10. The oil tank according to claim 9, wherein the at least one passage comprises a conduit extending from the transverse wall into the wheel.

11. The oil tank according to claim 10, wherein the conduit extends over at least 80% of a height of the wheel along a main direction of said conduit.

12. The oil tank according to claim 9, wherein the at least one passage comprises a valve adapted to allow a flow of oil from the upper compartment to the lower compartment and to block a flow of oil from the lower compartment to the upper compartment.

13. The oil tank according to claim 9, wherein the oil outlet on the lower compartment is an auxiliary oil outlet, said oil tank comprising an auxiliary oil inlet on said lower compartment.

14. A hydraulic system for an aircraft turbomachine comprising:
the oil tank according to claim 1;
a lubrication circuit of the turbomachine, hydraulically connected to the oil tank; and
a hydraulic control circuit including at least one hydraulic actuator, hydraulically connected to the oil tank; wherein the lubrication circuit is hydraulically connected to the oil inlet and to the oil outlet, arranged on the enclosure, the hydraulic control circuit being hydraulically connected to the auxiliary inlet and to the auxiliary outlet.

15. An aircraft turbomachine, comprising:
an unducted propeller propelling an incoming air flow, said unducted propeller comprising variable-pitch blades actuated by at least one hydraulic actuator; and
the hydraulic system of claim 14, the hydraulic system providing lubrication of the turbomachine and of controlling the at least one hydraulic actuator.
